(19) United States
(12) Patent Application Publication
(10) Pub. No.: US 2023/0079280 A1
(43) Pub. Date: Mar. 16, 2023

(54) DRIVER SOFTWARE

(71) Applicant: Kathy Young, Woodstock, GA (US)

(72) Inventor: Kathy Young, Woodstock, GA (US)

(21) Appl. No.: 17/475,336

(22) Filed: Sep. 14, 2021

(51) Int. Cl. G06Q 10/08

(52) U.S. Cl. CPC G06Q 10/0835

(57) ABSTRACT

Implementations of a driver software are provided. In some implementations, the driver software comprises a mobile application for a portable computing device, such as a mobile phone, or a software application for a desktop computing device, such as a desktop computer. In some implementations, the driver software comprises a website application for a portable computing device or a desktop computing device. In some implementations, a method of using the driver software comprises allowing drivers to create and maintain a profile, assigning a unique identifier to each driver, receiving and storing information related to each driver and the driver's truck, and allowing a customer to retrieve a driver's information based on the unique identifier.

### CROSS REFERENCE TO RELATED APPLICATION

This application claims the benefit of U.S. Patent Application Ser. No. 63/051,391, which was filed on Jul. 14, 2020, and is incorporated herein by reference in its entirety.

### TECHNICAL FIELD

This disclosure relates to implementations of a driver software.

### BACKGROUND

All industries need drivers to ship freight. However, there is no means to know beforehand information about a driver that is arriving to pick-up and deliver freight. This poses a huge risk, such as to security. Existing software maintains information about a carrier but not about drivers. Therefore, there does not exist software that allows customers, such as carriers, brokers, shippers, or receivers, to review information about a driver before the driver arrives to pick-up and deliver freight.

### BRIEF DESCRIPTION OF THE DRAWINGS

FIG. 1 illustrates an implementation of an example environment of a driver software according to the present disclosure.

FIG. 2 illustrates an example computer system, which may be used with implementations of the present disclosure.

FIGS. 3A-3C illustrate implementations of an example method for the driver software in the environment of FIG. 1 according to the present disclosure.

FIGS. 4A-4H illustrate implementations of example user interfaces of the driver software according to the present disclosure.

FIGS. 5A-5E illustrate other implementations of example user interfaces of the driver software according to the present disclosure.

### DETAILED DESCRIPTION

Implementations of a driver software are provided. In some implementations, the driver software comprises a mobile application for a portable computing device, such as a mobile phone (or “smart phone”) or similar device (e.g., an iPhone® or iPad®). In some implementations, the driver software comprises a software application for a desktop computing device, such as a desktop computer. In some implementations, the driver software comprises a website application for a portable computing device or a desktop computing device, such as the foregoing examples. The driver software may therefore be described or otherwise referred to collectively herein the present disclosure as an “application” or “software” for a “computing device”.

In some implementations, the driver software is configured to allow customers, such as carriers, brokers, shippers, or receivers, to review information about a driver before the driver arrives to pick-up and deliver freight or otherwise provide services.

In some implementations, the mobile application for portable computing devices and the software application for desktop computing devices are configured to primarily be used by drivers (e.g., professional truck drivers) or similar users. However, in some implementations, the mobile application and the software application may be further configured to be used by any other suitable users.

In some implementations, the mobile application and the software application are configured to be used with a portable computing device and a desktop computing device, respectively, or with any other suitable device.

In some implementations, the mobile application and the software application are configured to allow drivers or similar users to setup a profile, report the status of current shipments, and review the history of their shipments, such as further described below.

In some implementations, the website application for a portable computing device or a desktop computing device is configured to primarily be used by users who need to track the status of shipments, view driver profiles, and perform other related tasks, such as carriers, brokers, freight forwarders, agents, shippers, or receivers. However, in some implementations, the website application may be further configured to be used by any other suitable users.

In some implementations, the website application is configured to be accessed using a portable computing device, a desktop computing device, or any other suitable device.

In some implementations, the website application is configured to provide administrative features for users who have applicable permissions, such as to manage other users and to view additional information about drivers and shipments.

In some implementations, the website application is configured to also provide all of the server interfaces (e.g., application programming interfaces or API) that are used by the mobile and software applications.

In some implementations, the driver software is configured such that each driver can create and maintain a profile. In some implementations, the profile includes one or more pictures. In some implementations, the profile may include any other suitable content.

In some implementations, one or more of the profile pictures are related to the driver. For example, in some implementations, the profile includes a picture of the driver. In some implementations, the profile includes a picture of the driver's license. In some implementations, the driver related profile pictures may include any other suitable images.

In some implementations, one or more of the profile pictures are related to the driver's truck. For example, in some implementations, the profile includes a picture of the driver's truck. In some implementations, the profile includes a picture of the information required to be printed or otherwise displayed on the door of the driver's truck. In some implementations, the profile includes a picture of the tag or license plate of the driver's truck. In some implementations, the driver's truck related profile pictures may include any other suitable images.

In some implementations, the driver software is configured to assign a unique number or other identifier to each driver. In some implementations, the driver software is configured to allow a user to retrieve a driver's information from the driver software based on the unique number or other identifier.

In some implementations, the driver software is configured to receive and store certifications. For example, in some implementations, the driver software is configured to receive and store Transportation Security Administration (TSA) certifications. In some implementations, the driver software may be configured to receive and store any other suitable certifications.

In some implementations, the driver software is configured to receive and store endorsements. For example, in some implementations, the driver software is configured to receive and store hazardous materials (HAZMAT) endorsements. In some implementations, the driver software may be configured to receive and store any other suitable endorsements.

In some implementations, the driver software is configured to receive and store bond information. For example, in some implementations, the driver software may be configured to receive and store freight broker bond information. In some implementations, the driver software may be configured to receive and store motor vehicle registration bond information. In some implementations, the driver software may be configured to receive and store any other suitable bond information.

In some implementations, the driver software is configured to track the driver's truck. For example, in some implementations, the driver software may be configured to track the location of the driver's truck. In some implementations, the driver software may be configured to track the mileage of the driver's truck. In some implementations, the driver software may be configured to track the driver's truck in any other suitable way.

In some implementations, the driver software is configured to allow a customer, such as a carrier, a broker, a shipper, or a receiver, or other applicable user to rate or otherwise review a driver. For example, in some implementations, the driver software may be configured to allow a customer to rate or otherwise review the driver's freight pick-up and/or delivery performance. In some implementations, the driver software may be configured to allow a customer or other user to rate or otherwise review any other suitable aspect of a driver.

In some implementations, the driver software may be configured to provide any other suitable features to allow a customer to review information about a driver before the driver arrives to pick-up and deliver freight or otherwise provide services.

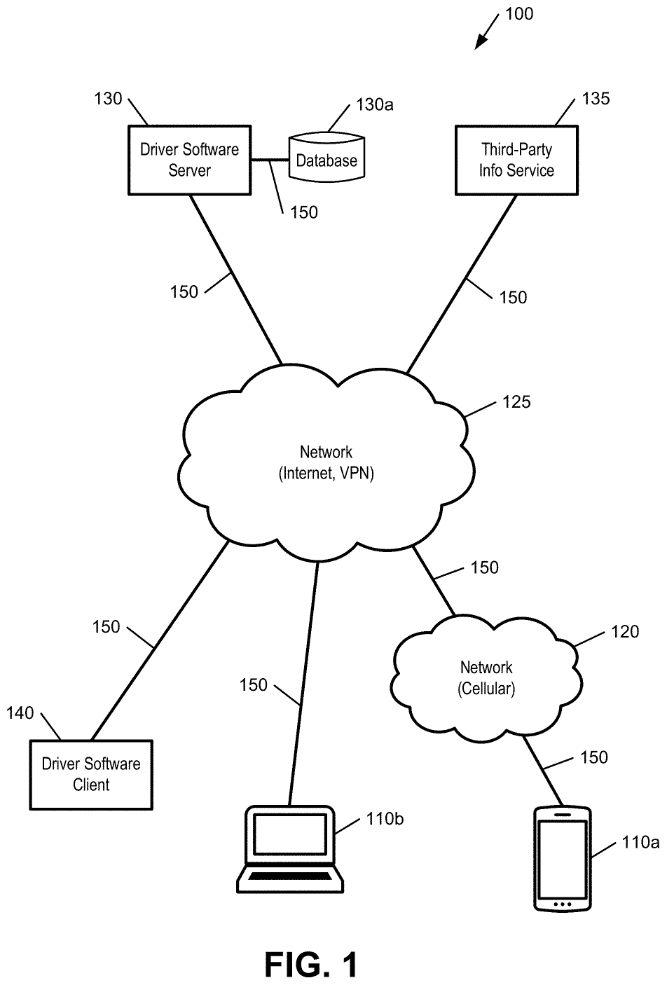

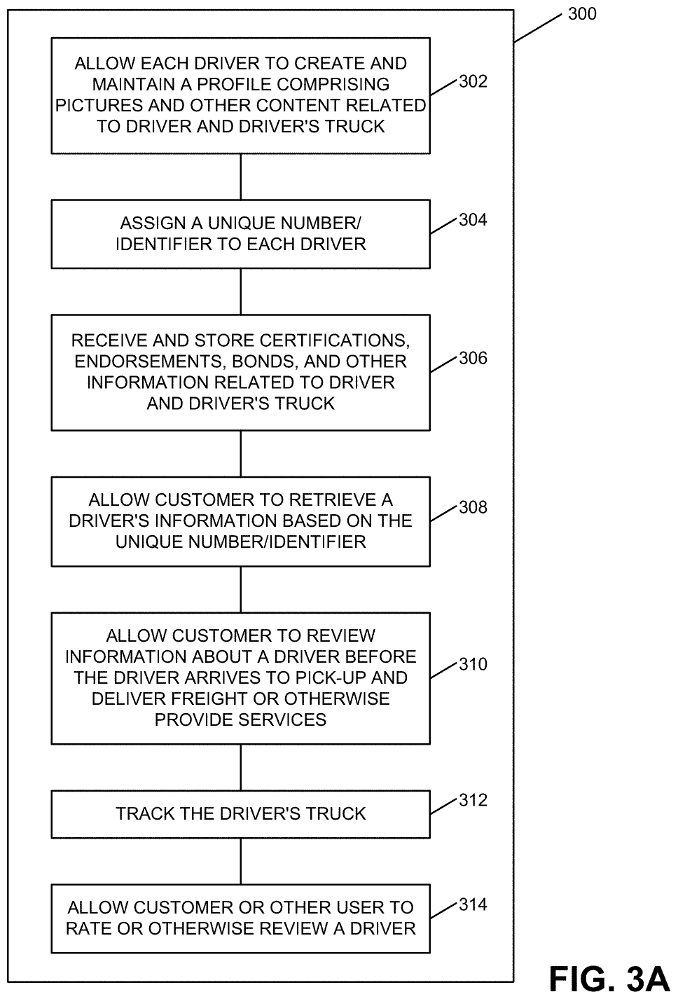

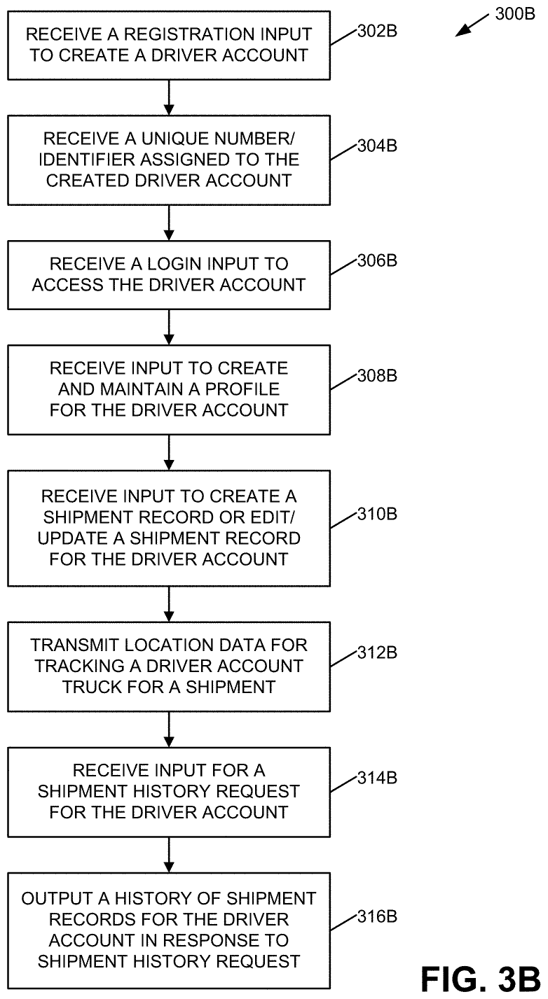

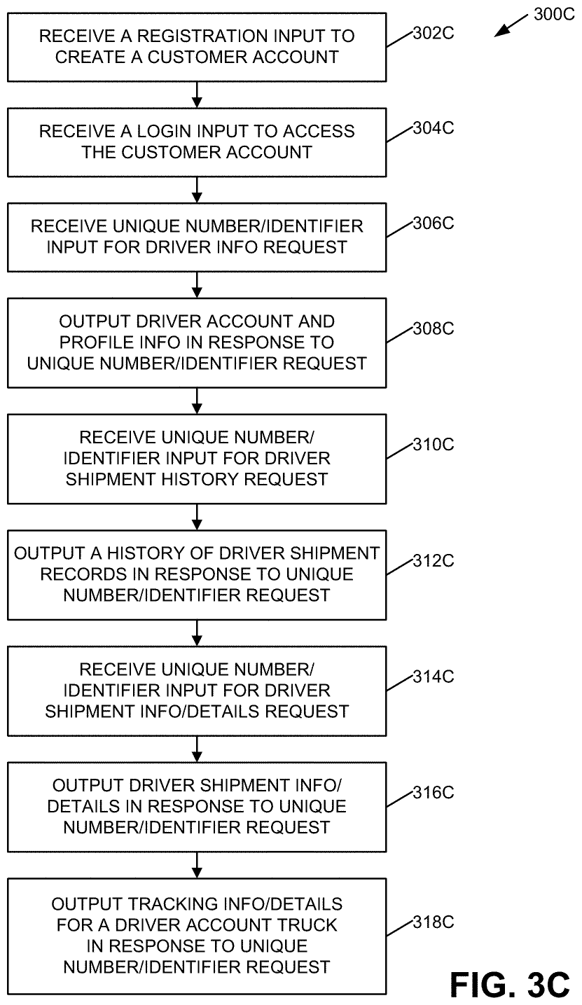

FIG. 3A illustrates an implementation of an example method 300 for the driver software in the environment of FIG. 1 (described below) according to the present disclosure. In some implementations, the method 300 is performed using the driver software on a portable computing device 110a, such as a mobile phone, or on a desktop computing device 110b, such as a desktop computer, (collectively “computing device 110” or “client 110”, described below for FIG. 1). Furthermore, in some implementations, the method 300 is performed by the driver software on a computing device 110 and/or a driver software client device 140 (described below for FIG. 1) in communications with one or more servers 130, 135 (also described below for FIG. 1).

In some implementations, the method 300 comprises the combined features of the application (i.e., the mobile application and/or the software application) and the website application as described herein.

In some implementations, the method 300 comprises the driver software allowing 302 each driver to create and maintain a profile. As described above, in some implementations, the profile comprises pictures and/or other content related to the driver and/or the driver's truck.

In some implementations, the method 300 comprises the driver software assigning 304 a unique number or other identifier to each driver, as described above.

In some implementations, the method 300 comprises the driver software receiving and storing 306 information related to the driver and/or the driver's truck. As described above, in some implementations, the information comprises certifications, endorsements, bonds, and/or other information.

In some implementations, the method 300 comprises the driver software allowing 308 a customer to retrieve a driver's information based on the assigned unique number or other identifier. As described above, in some implementations, the customer may be a carrier, a broker, a shipper, a receiver, or other applicable user.

In some implementations, the method 300 comprises the driver software allowing 310 a customer to review information about a driver before the driver arrives to pick-up and deliver freight or otherwise provide services. In some implementations, such information includes the above described profile and other information related to a driver and/or the driver's truck.

In some implementations, the method 300 comprises the driver software tracking 312 a driver's truck. As described above, in some implementations, such tracking may comprise tracking the location, mileage, etc. of the driver's truck.

In some implementations, the method 300 comprises the driver software allowing 314 a customer or other user to rate or otherwise review a driver. For example as described above, in some implementations, the driver software may allow a customer to rate or otherwise review the driver's freight pick-up and/or delivery performance.

FIG. 3B illustrates an implementation of another example method 300B for the driver software in the environment of FIG. 1 (described below) according to the present disclosure. In some implementations, the method 300B is performed using the driver software on a portable computing device 110a, such as a mobile phone, or on a desktop computing device 110b, such as a desktop computer, (collectively “computing device 110” or “client 110”, described below for FIG. 1). Furthermore, in some implementations, the method 300B is performed by the driver software on a computing device 110 and/or a driver software client device 140 (described below for FIG. 1) in communications with one or more servers 130, 135 (also described below for FIG. 1).

In some implementations, the method 300B comprises the features of the application (i.e., the mobile application and/or the software application) as described herein.

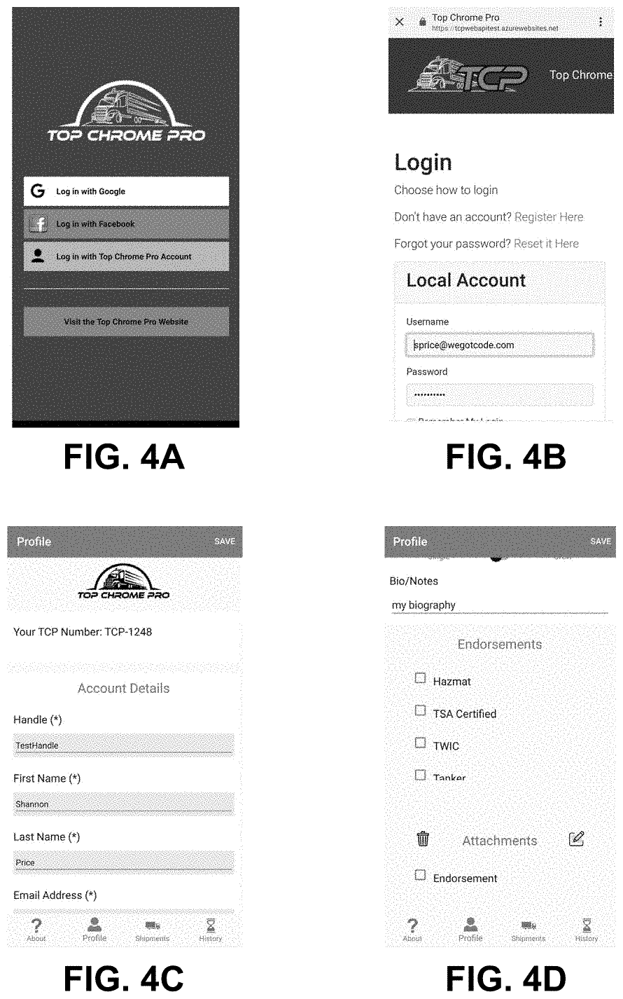

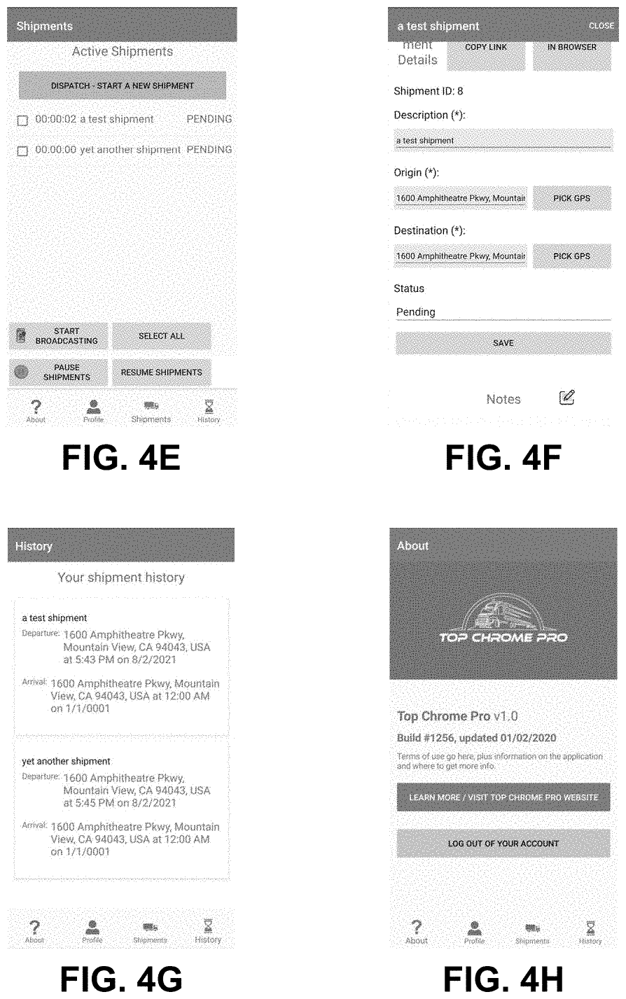

In some implementations, the method 300B comprises receiving 302B a registration input to create a driver account, such as described below for FIGS. 4A and 4B.

In some implementations, the method 300B comprises receiving 304B a unique number/identifier assigned to the created driver account as described herein.

In some implementations, the method 300B comprises receiving 306B a login input to access the driver account, such as described below for FIGS. 4A and 4B.

In some implementations, the method 300B comprises receiving 308B input to create and maintain a profile for the driver account, such as described below for FIGS. 4C and 4D and furthermore herein.

In some implementations, the method 300B comprises receiving 310B input to create a shipment record or edit/update a shipment record for the driver account, such as described below for FIGS. 4E and 4F.

In some implementations, the method 300B comprises transmitting 312B location data for tracking a driver account truck for a shipment, such as described below for FIGS. 4E and 4F and furthermore herein.

In some implementations, the method 300B comprises receiving 314B input for a shipment history request for the driver account, such as described below for FIG. 4G.

In some implementations, the method 300B comprises outputting 316B a history of shipment records for the driver account in response to shipment history request, such as described below for FIG. 4G.

In some implementations, the method 300B may further comprise receiving other inputs and/or outputting other information and communications related to the driver account.

FIG. 3C illustrates an implementation of another example method 300C for the driver software in the environment of FIG. 1 (described below) according to the present disclosure. In some implementations, the method 300C is performed using the driver software on a portable computing device 110a, such as a mobile phone, or on a desktop computing device 110b, such as a desktop computer, (collectively “computing device 110” or “client 110”, described below for FIG. 1). Furthermore, in some implementations, the method 300C is performed by the driver software on a computing device 110 and/or a driver software client device 140 (described below for FIG. 1) in communications with one or more servers 130, 135 (also described below for FIG. 1).

In some implementations, the method 300C comprises the features of the website application (e.g., for a server or other website computing device) as described herein.

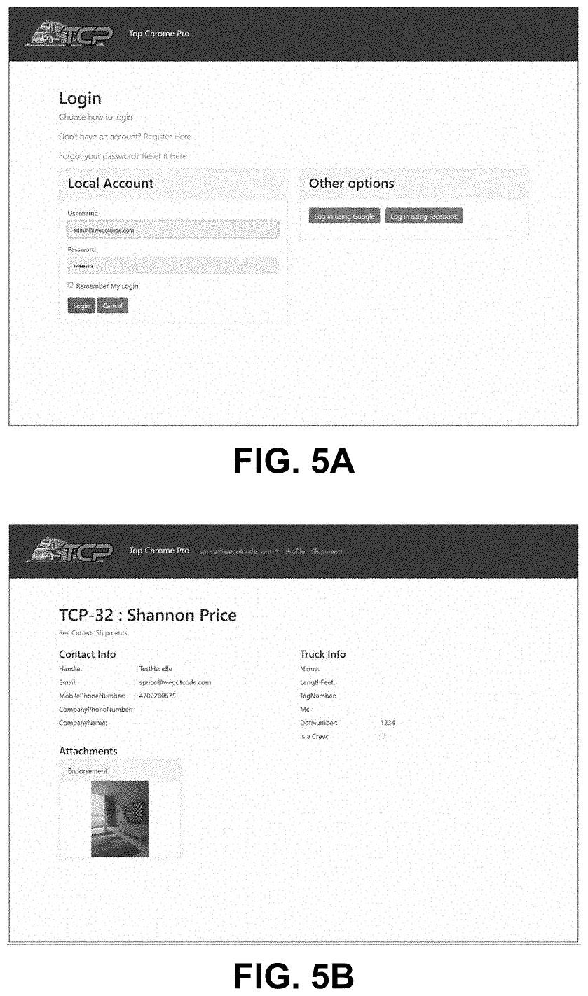

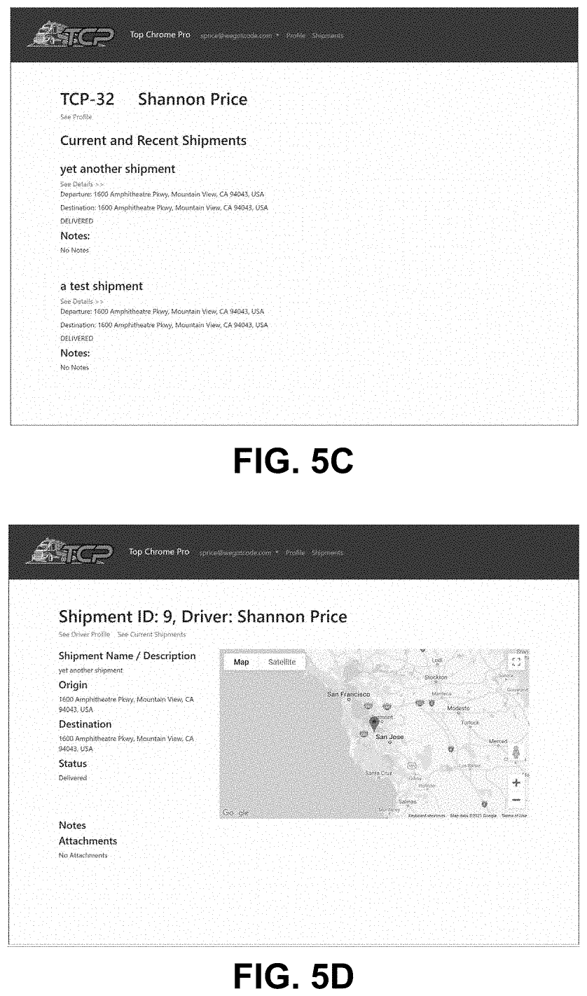

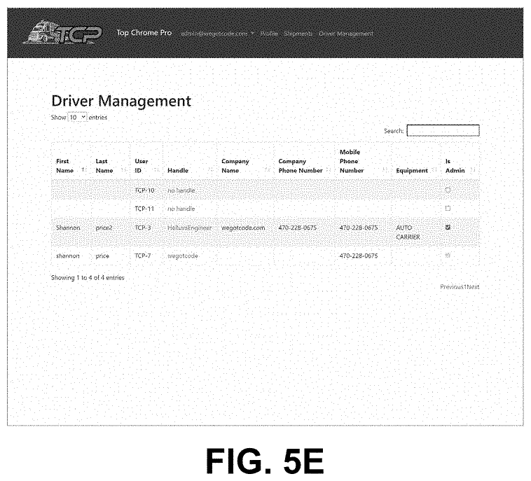

In some implementations, the method 300C comprises receiving 302C a registration input to create a customer account, such as described below for FIG. 5A. In some implementations, the method may further comprise receiving a unique number/identifier assigned to the created customer account.

In some implementations, the method 300C comprises receiving 304C a login input to access the customer account, such as described below for FIG. 5A.

In some implementations, the method 300C comprises receiving 306C a unique number/identifier input for a driver information request, such as described below for FIG. 5B.

In some implementations, the method 300C comprises outputting 308C driver account and profile info in response to unique number/identifier request, such as described below for FIG. 5B.

In some implementations, the method 300C comprises receiving 310C a unique number/identifier input for a driver shipment history request, such as described below for FIG. 5C.

In some implementations, the method 300C comprises outputting 312C a history of driver shipment records in response to the unique number/identifier request, such as described below for FIG. 5C.

In some implementations, the method 300C comprises receiving 314C a unique number/identifier input for a driver shipment information and/or details request (e.g., for a specific shipment), such as described below for FIG. 5D.

In some implementations, the method 300C comprises outputting 316C driver shipment information and/or details in response to unique number/identifier request, such as described below for FIG. 5D.

In some implementations, the method 300C comprises outputting 318C tracking info/details for a driver account truck in response to unique number/identifier request, such as described below for FIG. 5D and furthermore herein.

In some implementations, the method 300C may further comprise receiving other inputs and/or outputting other information related to a driver account.

In some implementations, the method 300C may further comprise performing administrative tasks, such as described below for FIG. 5E.

FIGS. 4A-4H illustrate implementations of example user interfaces of the driver software according to the present disclosure. In some implementations, the user interfaces may be for the mobile application for a portable computing device or the software application for a desktop computing device.

FIGS. 4A and 4B illustrate an implementation of an example user interface of the driver software for a user to log in. As shown in FIG. 4A, in some implementations, a user can log in to the driver software (or authenticate) through a user account or a social media account (e.g., Google or Facebook). In some implementations, a user may be able to log in through any other suitable account.

As shown in FIG. 4B, in some implementations, if a user does not have an account, the user can select to create an account (or register). In some implementations, if a user has forgotten or wants to change the user's password, the user can select to reset the password.

In some implementations, each account may be tied to a driver profile.

As shown in FIG. 4A, in some implementations, a link or selection icon is provided to access an informational website and/or the website application.

FIGS. 4C and 4D illustrate an implementation of an example user interface of the driver software for users to create and/or modify their profile. As shown in FIGS. 4C and 4D, in some implementations, the profile user interface comprises fields such as for a handle or nickname, first and last names, email address(es), a short biography (or bio), brief notes, and endorsements.

In some implementations, the profile user interface further comprises fields for phone number(s), company name, Department of Transportation (DOT) and Motor Carrier (MC) numbers, equipment and truck type, trailer number, tag number and state, residency status, trailer length, and single or crew status.

As shown in FIG. 4D, in some implementations, the profile user interface allows a user to attach files, pictures, etc. For example, in some implementations, the attachment types that can be selected with the profile user interface include profile photo, driver's license, endorsement, license plate, truck photo, and other.

In some implementations, the driver software is configured to launch a device or system camera to photograph documents or other items for attachments through the profile user interface.

FIGS. 4E and 4F illustrate an implementation of an example user interface of the driver software for shipments and shipment status. As shown in FIGS. 4E and 4F, in some implementations, the shipments user interface is configured to allow a user to create a new shipment and/or update a shipment status.

In some implementations, the driver software is configured such that use of the shipments user interface triggers the tracking of the current user's location.

As shown in FIGS. 4E and 4F, in some implementations, the shipments user interface is configured to allow a user to create and edit shipment details such as a shipment description, origin and destination (e.g., by address or GPS coordinates), and current status (e.g., pending, in transit, paused, or delivered). In some implementations, the shipments user interface is further configured to allow a user to create and edit shipment details by adding notes and adding attachments (such as described above for a driver profile).

As shown in FIGS. 4E and 4F, in some implementations, the shipments user interface is also configured to allow a user (such as a driver) to turn on or off broadcasting of location (e.g., using GPS). In some implementations, the user can copy a link to access the shipment info on the driver software website or website application that can be sent to others via text/SMS, email, etc.

In some implementations, the shipments user interface is also configured to allow a user (such as a driver) to pause or un-pause individual shipments or all shipments. In some implementations, if a shipment is paused, the driver is prompted to specify a reason through the shipments user interface.

FIG. 4G illustrates an implementation of an example user interface of the driver software for shipment and related history. As shown in FIG. 4G, in some implementations, the history user interface is configured to allow a user (such as a driver) to review the user's history over a previous period (e.g., the last 30 days).

In some implementations, the history comprises a shipping description, departure location, and arrival location. In some implementations, the history comprises timestamps for the shipping events.

FIG. 4H illustrates an implementation of an example user interface of the driver software for information about and related to the driver software application. As shown in FIG. 4H, in some implementations, the about user interface is configured to provide information about the driver software application, a link or selection icon to the driver software website and/or website application, and a button or selection icon to log out a user from the driver software application.

In some implementations, the about user interface may be further configured to provide links or selection icons to the driver software terms of service and privacy policy, such as which are presented for agreement during installation of the driver software application to a user's computing device.

FIGS. 5A-5E illustrate other implementations of example user interfaces of the driver software according to the present disclosure. In some implementations, the user interfaces may be for the website application for a portable computing device or a desktop computing device.

FIG. 5A illustrates an implementation of an example user interface of the driver software for a user (such as a customer) to log in. As shown in FIG. 5A, in some implementations, the login user interface comprises the same or similar features as described above for the login user interface of FIGS. 4A and 4B.

FIG. 5B illustrates an implementation of an example user interface of the driver software for a user (such as a customer) to view driver profile information, including public attachments. As shown in FIG. 5B, in some implementations, the profile-view user interface provides all or most of the driver profile information described above for the profile user interface of FIGS. 4C and 4D.

In some implementations, the profile-view user interface is configured to display a driver profile based on an input of the unique number or other identifier assigned for each driver profile after user registration.

In some implementations, a user with administrator permissions can also view private attachments of a driver profile.

FIG. 5C illustrates an implementation of an example user interface of the driver software for a user (such as a customer) to view current and recent shipments. For example, in some implementations, the shipments-list user interface is configured to display all current and recent shipments of a driver (e.g., requested by entering the driver's unique number/identifier).

As shown in FIG. 5C, in some implementations, the shipments-list user interface provides all or most of the shipment and related history information described above for the history user interface of FIG. 4G.

FIG. 5D illustrates an implementation of an example user interface of the driver software for a user (such as a customer) to view shipment details. As shown in FIG. 5D, in some implementations, the shipments-details user interface provides all or most of the shipment details information described above for the shipments user interface of FIGS. 4E and 4F, such as a shipment description, origin and destination (e.g., by address or GPS coordinates), and current status (e.g., pending, in transit, paused, or delivered). In some implementations, the shipments-details user interface also provides shipment detail notes (including paused shipment details) and attachments if these items exist.

As shown in FIG. 5D, in some implementations, the shipments-details user interface is also configured to display the shipment driver's last known location on a map and/or otherwise provide this location information.

FIG. 5E illustrates an implementation of an example user interface of the driver software for administrative (“admin”) management of registered users. In some implementations, the administrative management user interface is an admin-only user interface, for example for driver software staff use.

As shown in FIG. 5E, in some implementations, the admin management user interface is configured to allow an admin user to review a listing of drivers and/or other users registered in the driver software system.

In some implementations, the admin management user interface is configured to allow an admin user to search the list of users in various ways, such as by name, unique number/identifier, etc.

In some implementations, the admin management user interface is configured to allow an admin user to select for a user in the listing to have admin permissions. In some implementations, such admin permissions will allow the user to have access to special features such as the admin management user interface and private attachments of other users.

In some implementations, the admin management user interface is also configured to provide a link or selection icon to each driver's profile.

FIG. 1 illustrates an implementation of an example environment of a driver software 100 according to the present disclosure.

As shown in FIG. 1, in some implementations, the environment 100 may include one or more client devices 110a and 110b (collectively “client devices 110”), wireless cellular network 120, network 125, driver software servers 130, third-party information services servers 135, and driver software client devices 140. In some implementations, the environment 100 may also include one or more data storages 130a1 linked to the servers 130.

As discussed above, in some implementations, a computing device (“client device”) 110, 140 may be used to create and maintain a profile related to a driver and/or the driver's truck. In some implementations, the driver software server 130 may receive information related to a driver and/or the driver's truck from the client device 110, 140 and/or the third-party information server 135. In some implementations, the received information is stored in a database 130a of the driver software server 130.

As discussed above, in some implementations, the driver software server 130 may assign a unique number or other identifier to each driver, which may be stored in a database 130a of the driver software server 130. In some implementations, a driver's information may be retrieved from the driver software server 130 via a client device 110, 140 based on the assigned unique number or other identifier.

As discussed above, in some implementations, the driver software server 130 may track a driver's truck via the client device 110, 140.

As discussed above, in some implementations, information about a driver can be reviewed using a client device 110, 140 before the driver arrives to pick-up and deliver freight or otherwise provide services. In some implementations, a driver's performance can be rated or otherwise reviewed using a client device 110, 140. In some implementations, the rating or other review information may be stored in a database 130a of the driver software server 130.

Client devices 110a and 110b (collectively “client devices 110”) are depicted as a mobile phone 110a and a desktop computer 110b, respectively, but client devices 110 may comprise any type of computing device, such as a desktop computer system, a laptop, cellular phone, a smart device, a mobile telephone, a tablet-style computer, or any other device capable of wireless or wired communication. Similarly, the driver software client device 140 may also comprise any type of computing device, such as a desktop computer system, a laptop, cellular phone, a smart device, a mobile telephone, a tablet-style computer, or any other device capable of wireless or wired communication. In some implementations, client devices 110, 140 are configured to interact with the server 130 via an application, such as a web browser or a native application, residing on the client device 110, 140.

In some implementations, the client devices 110, 140 include hardware, software, or embedded logic components or a combination of two or more such components and is configured to carry out the appropriate functions implemented or supported by the client devices 110, 140.

In some implementations, the client devices 110, 140 may include one or more processors, one or more memories, one or more displays, one or more interfaces, one or more components capable of inputting data, one or more components capable of outputting data, one or more components capable of communicating with any other component of the environment 100 or any other component suitable for a particular purpose.

In some implementations, the client devices 110, 140 are configured to access networks 120 and/or 125. In some implementations, the client devices 110, 140 are configured to communicate with servers 130.

In some implementations, the client devices 110, 140 can connect to the network 125 through a wireless cellular network 120, such as GPRS-based and CDMA-based wireless networks, as well as 802.16 WiMax and long-range wireless data networks.

In some implementations, components of the environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN

(WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server devices 130 may include a processor, memory, user accounts, and one or more modules to perform various functions such as those described above.

In some implementations, each server 130 may be a unitary server or may be a distributed server spanning multiple computers or multiple datacenters. Servers 130 may be of various types, such as, for example and without limitation, web server, file server, application server, exchange server, database server, or proxy server. In some implementations, each server 130 may include hardware, software, or embedded logic components or a combination of two or more such components for carrying out the appropriate functionalities implemented or supported by server 130. For example, a web server is generally capable of hosting websites containing web pages or particular elements of web pages. More specifically, a web server may host HTML files or other file types, or may dynamically create or constitute files upon a request, and communicate them to clients 110, 140 in response to HTTP or other requests from clients 110, 140. A database server is generally capable of providing an interface for managing data stored in one or more data stores.

In some implementations, one or more data storages 130a may be communicatively linked to one or more servers 130, respectively, via one or more links 150. In some implementations, data storages 130a may be used to store various types of information. In some implementations, the information stored in data storages 130a may be organized according to specific data structures. In particular embodiment, each data storage 130a may be a relational database. Particular embodiments may provide interfaces that enable servers 130 or clients 110, 140 to manage, e.g., retrieve, modify, add, or delete, the information stored in data storage 130a.

Although the driver software is describe herein as comprising an application (i.e., a mobile application and/or a software application) and a website application (e.g., for a server or other website computing device), in some implementations, the driver software may comprise other suitable configurations. For example, in some implementations, the features of the driver software described herein may be comprised in a single mobile application or two or more different mobile applications, in a single software application or two or more different software applications, in a single website application or two or more different website applications, and/or any suitable combination of the foregoing applications.

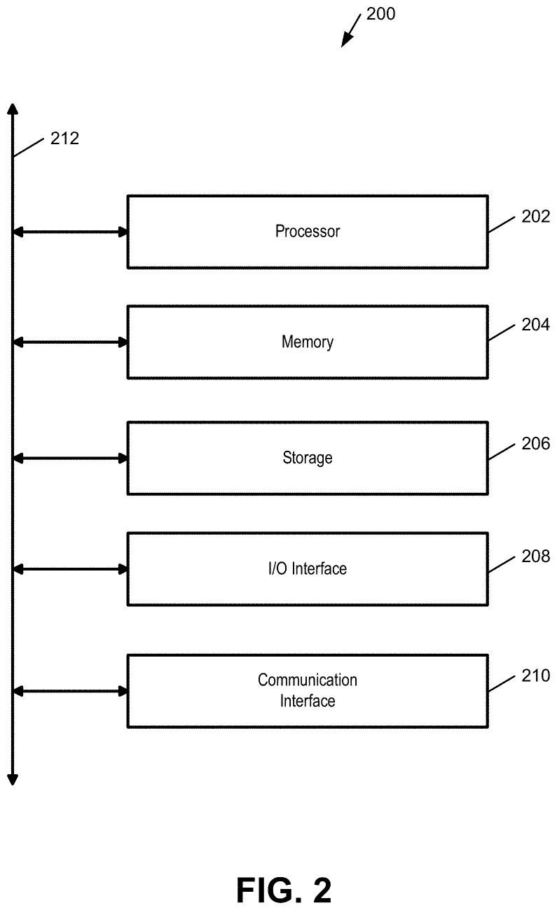

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

The figures, including photographs and drawings, comprised herewith may represent one or more implementations of the driver software.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A computer-implemented method for driver information and tracking, the method comprising:
allowing drivers to create and maintain a profile;
assigning a unique identifier to each driver;
receiving and storing information related to each driver and the driver's truck; and
allowing a customer to retrieve a driver's information based on the unique identifier.
